(19) United States
(12) Patent Application Publication
(10) Pub. No.: US 2021/0036617 A1
(43) Pub. Date: Feb. 4, 2021

(54) METHODS AND APPARATUSES FOR A MULTI-MODE REGULATOR ARCHITECTURE

(71) Applicant: QUALCOMM Incorporated, San Diego, CA (US)

(72) Inventors: Chunping SONG, Palo Alto, CA (US); Hector Ivan Oporta, San Jose, CA (US); Sumukh Shevde, San Diego, CA (US)

(21) Appl. No.: 16/944,913

(22) Filed: Jul. 31, 2020

Related U.S. Application Data
(60) Provisional application No. 62/882,392, filed on Aug. 2, 2019.

(51) Int. Cl. H02M 3/158; H02M 3/157; H02J 7/00

(52) U.S. Cl. CPC H02M 3/1582; H02M 2001/0045; H02J 7/0068; H02M 3/157

(57) ABSTRACT

Aspects of the present disclosure generally relate to multi-mode regulators. For example, the multi-mode regulator may include a first transistor having a first terminal coupled to an input voltage and a second terminal coupled to an output of the regulator, a second transistor having a first terminal coupled to the second terminal of the first transistor and a second terminal coupled to a reference potential, pulse width modulation (PWM) control logic having outputs coupled to gates of a first transistor and a second transistor, one or more error amplifiers, and a switch with a first terminal coupled to the gate of the first transistor and a second terminal coupled to the output of one of the one or more error amplifiers. By selectively configuring one or more components of the multi-mode regulator, the regulator may operate according to either a linear regulation mode or a switching regulation mode.

### CLAIM FOR PRIORITY UNDER 35 U.S.C. § 119

The present application of patent claims priority to Provisional Application No. 62/882,392 entitled “METHODS AND APPARATUSES FOR A MULTI-MODE REGULATOR ARCHITECTURE” filed Aug. 2, 2019, and assigned to the assignee hereof and hereby expressly incorporated by reference herein.

### FIELD

Certain aspects of the present disclosure generally relate to electronic circuits and, more particularly, to a circuit for a multi-mode regulator.

### BACKGROUND

Power management integrated circuits (power management ICs or PMICs) are used for managing the power requirement of a host system. A PMIC may be used in battery-operated devices, such as mobile phones, tablets, laptops, wearables, etc., to control the flow and direction of electrical power in the devices. The PMIC may perform a variety of functions for the device such as DC to DC conversion, battery charging, power-source selection, voltage scaling, power sequencing, etc.

### SUMMARY

Certain aspects of the present disclosure generally relate to a regulator supporting multiple modes. The regulator generally includes a first transistor having a first terminal coupled to an input voltage and a second terminal coupled to an output of the regulator, a second transistor having a first terminal coupled to the second terminal of the first transistor and a second terminal coupled to a reference potential, pulse width modulation (PWM) control logic having a first output coupled to a gate of the first transistor and a second output coupled to a gate of the second transistor, one or more error amplifiers configured to receive a reference value and a feedback value, at least one comparator of the one or more error amplifiers having an output coupled to an input of the PWM control logic, and a switch with a first terminal coupled to the gate of the first transistor and a second terminal coupled to the output of one of the one or more error amplifiers.

Certain aspects of the present disclosure provide for a method of multi-mode regulation. The method generally includes selecting a regulation mode from a plurality of modes of a regulator, selectively configuring one or more components of the regulator based on the selected mode, and regulating an output of the selectively configured regulator according to the selected mode.

Certain aspects of the present disclosure provide for a multi-mode regulator. The multi-mode regulator generally includes means for selectively configuring one or more components of the regulator based on a selected regulation mode, the selected regulation mode being selected from among a linear mode and switching mode supported by the multi-mode regulator, means for comparing a feedback value of the regulator against a reference value, and means for regulating the output of the multi-mode regulator based on the selected mode and an output of the means for comparing.

Certain aspects of the present disclosure provide for a battery charging architecture. The battery charging architecture generally includes a multi-mode regulator and a battery coupled to the output of the multi-mode regulator. The multi-mode regulator generally includes a first transistor having a first terminal coupled to an input voltage and a second terminal coupled to an output of the regulator, a second transistor having a first terminal coupled to the second terminal of the first transistor and a second terminal coupled to a reference potential, pulse width modulation (PWM) control logic having a first output coupled to a gate of the first transistor and a second output coupled to a gate of the second transistor, one or more error amplifiers configured to receive a reference value and a feedback value, at least one error amplifier of the one or more error amplifiers having an output coupled to an input of the PWM control logic, and a switch with a first terminal coupled to the gate terminal of the first transistor and a second terminal coupled to the output of one of the one or more error amplifiers.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a block diagram of an example device including a multi-mode regulator, according to certain aspects of the present disclosure.

FIG. 2 illustrates an example implementation of a regulator supporting multiple modes, in accordance with certain aspects of the present disclosure.

FIG. 3 illustrates an example implementation of a multi-mode regulator with shared mode feedback, in accordance with certain aspects of the present disclosure.

FIG. 4 illustrates an example implementation of a multi-mode regulator with separate mode feedback, in accordance with certain aspects of the present disclosure.

FIG. 5 illustrates an example implementation of battery charging architecture using a multi-mode regulator operating according to a linear regulation mode, in accordance with certain aspects of the present disclosure.

FIG. 6 illustrates an example implementation of battery charging architecture using a multi-mode regulator operating according to a switching regulation mode, in accordance with certain aspects of the present disclosure.

FIG. 7 illustrates an example operation of a regulation method using a multi-mode voltage regulator architecture, in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

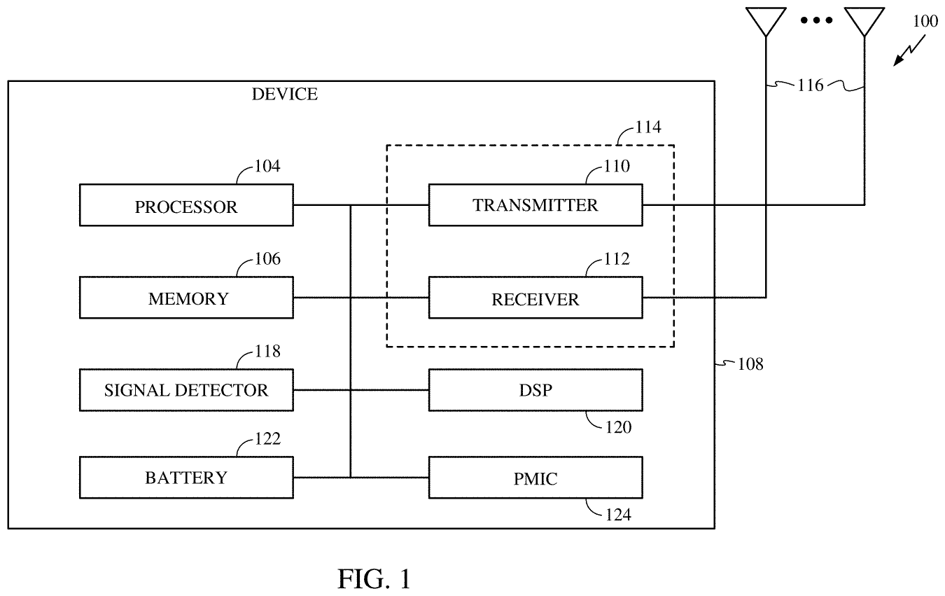

FIG. 1 illustrates a device 100. The device 100 may be a battery-operated device such as a cellular phone, a personal digital assistant (PDA), a handheld device, a wireless modem, a laptop computer, a tablet, a personal computer, etc. The device 100 is an example of a device that may be configured to implement the various systems and methods described herein.

The device 100 may include a processor 104 which controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106. The instructions in the memory 106 may be executable to implement the methods described herein.

The device 100 may also include a housing 108 that may include a transmitter 110 and a receiver 112 to allow transmission and reception of data between the device 100 and a remote location. The transmitter 110 and receiver 112 may be combined into a transceiver 114. A plurality of transmit antennas 116 may be attached to the housing 108 and electrically coupled to the transceiver 114. The device 100 may also include (not shown) multiple transmitters, multiple receivers, and multiple transceivers.

The device 100 may also include a signal detector 118 that may be used in an effort to detect and quantify the level of signals received by the transceiver 114. The signal detector 118 may detect such signal characteristics as total energy, energy per subcarrier per symbol, power spectral density and other signals. The device 100 may also include a digital signal processor (DSP) 120 for use in processing signals.

The device 100 may further include a battery 122 used to power the various components of the device 100. The device 100 may also include a power management integrated circuit (power management IC or PMIC) 124 for managing the power from the battery to the various components of the device 100. The PMIC 124 may perform a variety of functions for the device such as DC to DC conversion, battery charging, power-source selection, voltage scaling, power sequencing, etc. In certain aspects, the PMIC 124 includes one or more multi-mode regulators (e.g., operating as a low-dropout (LDO) regulator or as a switching regulator) as described herein and may be used for voltage and/or current regulation.

Certain aspects of this present disclosure generally relate to multi-mode regulators which may be configured to operate as either a linear regulator or as a switching regulator using a shared topology. Using a multi-mode regulator, as described herein, may provide several advantages, including improving flexibility of implementing different regulator designs using the same regulator architecture. For example, a manufacturer may offer a single chipset solution containing the multi-mode regulator to support either linear or switching regulator solutions as compared to being required to offer separate chipset solutions for each. By being able to reuse the same chipset for both linear and switching regulator solutions, a manufacture may be able to reduce costs by not having to design and support separate solutions. Furthermore, the multi-mode regulator may also be able to actively switch between linear and switching regulation modes during device operation. By being able to switch between regulation modes actively, a device may able determine which regulation mode is suited for current operating conditions in an effort to improve performance. Examples of performance improvements include reducing ripple noise, improving efficiency, and reducing heat generation by one or more components of the regulator.

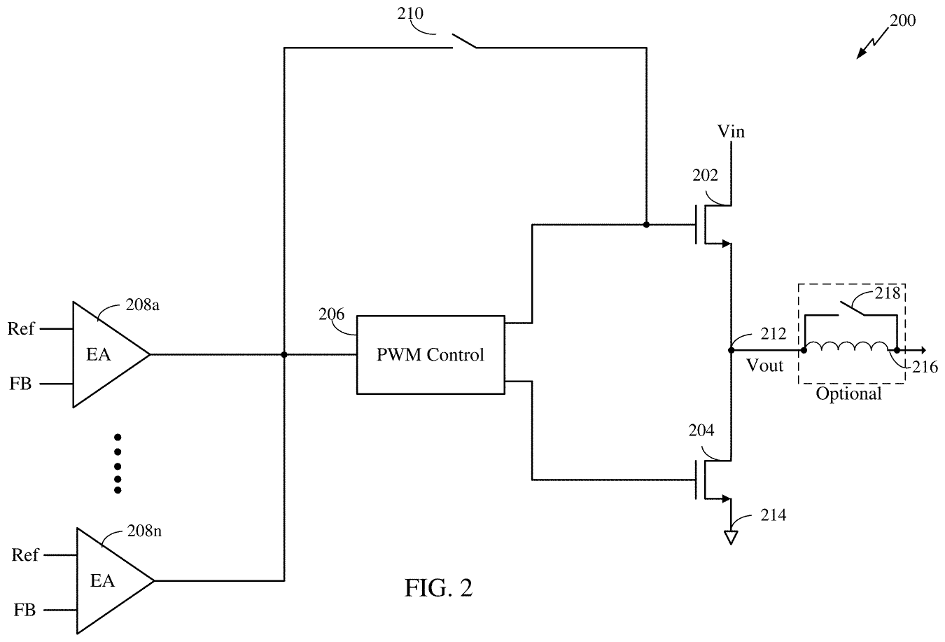

FIG. 2 illustrates an example regulator supporting multiple modes 200 (which may referred to as a “multi-mode regulator”), in accordance with certain aspects of the present disclosure. In one implementation, the multi-mode regulator 200 includes a first transistor 202, a second transistor 204, pulse wide modulation (PWM) control logic 206, one or more error amplifiers 208, and a mode switch 210. The first transistor 202 has a first terminal coupled to an input voltage Vin, a second terminal coupled to a first terminal of the second transistor 204 and an output voltage node Vout 212 where the second transistor 204 further has a second terminal coupled to a reference potential 214 (e.g., ground). In the exemplary implementation, the first transistor 202 and second transistor 204 comprise N-type metal-oxide-semiconductor (NMOS) transistors. However, the first and second transistors 202, 204 may be implemented using various transistor topologies, such as P-type metal-oxide-semiconductor (PMOS) transistors.

The PWM control logic 206 has a first output coupled to a gate terminal of the first transistor 202 and a second output coupled to a gate terminal of the second transistor 204. The PWM control logic 206 has one or more inputs coupled to the one or more error amplifiers (EA) 208. In one implementation, the PWM control logic 206 has a single input that selectively receives an output from only one EA of the one or more EAs 208 at a time. In another implementation, the PWM control logic 206 may have multiple inputs, each coupled to a respective output of the one or more EAs 208. The one or more EAs 208 are each configured to receive a reference value at one input and a corresponding feedback value at a second input and to output a difference value between the reference value and the feedback value to form a corresponding control loop. For example, a reference value may be a target voltage of a battery being charged by the multi-mode regulator 200 and the feedback value is a measured value a voltage of the battery to form a control loop for the battery voltage. Other examples include control loops for the input current of the multi-mode regulator 200 and the charging current into the battery being charged. In instances where reference and feedback values involve current information, the current information may be converted into voltage information prior to being provided to the inputs of the EA. By using different reference and feedback values, the dual mode regulator can be configured to regulate the output of the output voltage node 212 based on voltage and/or current according to the corresponding reference and feedback values.

The multi-mode regulator 200 is configurable to operate in either a linear regulation mode or a switching regulation mode. An example of a linear regulation mode includes operating the multi-mode regulator as a low dropout (LDO) regulator whereas an example of a switching regulation mode includes operating the multi-mode regulator as a buck, boost, or a buck-boost switching regulator.

When operating in a linear regulation mode, the first transistor 202 is controlled by an output of at least one EA of the one or more EAs 208 via a coupling of the EA output with the gate terminal of the first transistor 202 via the mode switch 210. The second transistor 204 is set to a defined state for linear regulation mode. For example, the second transistor 204 may be set to a defined state of being turned off (i.e., open). The bias for the defined state may be applied to the second transistor 204 by the PWM control logic 206 or by a separate circuit (not shown).

When operating in a switching regulation mode, the first transistor 202 and the second transistor 204 are controlled by the outputs of PWM control logic 206 coupled the respective gate terminals of the first and second transistors. In addition, the gate terminal of the first transistor 202 is uncoupled from the output of the at least one EA via the mode switch 210. The PWM control logic 206 operates the first transistor 202 and the second transistor 204 according to a switching regulator topology (e.g., a buck converter) using an output from at least one of the one or more EA 208. Furthermore, when operating in a switching regulation mode, an output inductor 216 (shown as optional) is coupled to the output voltage node 212. In one implementation, the output inductor may optionally be selectively coupled to the output voltage node 212 when operating in a switching regulator mode and uncoupled, such as via a bypass switch 218, when operating in a linear regulation mode. The bypass switch 218 may be control by a signal output by control logic locate an integrated circuit or chipset (e.g., a PMIC) implementing the multi-mode regulator.

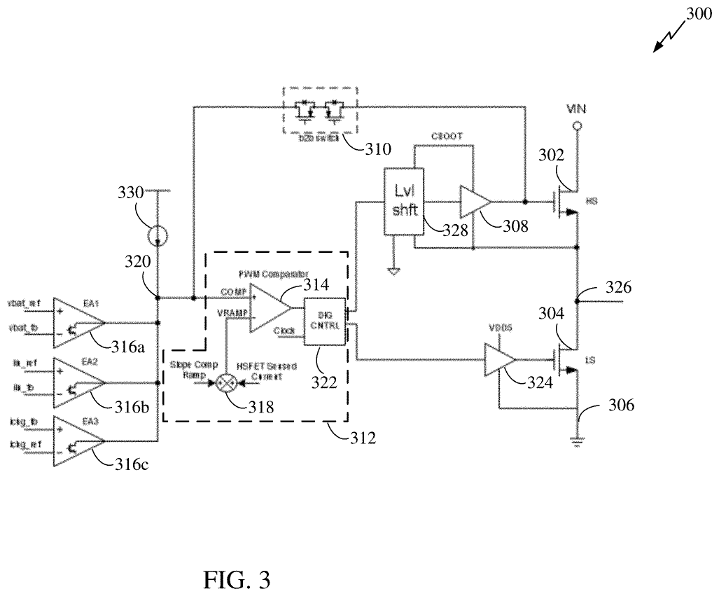

Referring now to FIG. 3, an example implementation of a multi-mode regulator 300 with shared mode feedback is illustrated, in accordance with various aspects of the present disclosure. The multi-mode regulator 300 includes a first transistor 302 (referred to herein as a high-side (HS) switch of the switching mode) and a second transistor 304 (referred to herein as a low-side (LS) switch of the switching mode). The first transistor 302 has drain terminal coupled to an input voltage VIN. The input voltage VIN may be provided from an internal power source, such as a battery, or via an external power source, such as a wall adapter, wireless charger, or via connection to peripheral device (e.g., a computer) configured to provide power. The source terminal of the first transistor 302 is coupled to an output voltage node and a drain terminal of the second transistor 304. The second transistor 304 further has a source terminal coupled to a reference potential 306 (e.g., ground). The gate terminal of the first transistor 302 is coupled to high-side driver amplifier 308 and a first terminal of a mode switch 310. In this example implementation, the mode switch 310 comprises a pair of PMOS transistors configured as a back-to-back (b2b) diode switch. The multi-mode regulator 300 further includes PWM control logic 312 configured to operate according to a peak current control mode. The PWM control logic 312 comprises a PWM comparator 314 having a first input coupled to the outputs a plurality of EAs 316a-c and a second input coupled to a voltage ramp signal (VRAMP), where VRAMP is based on a combination of a slope compensation ramp and a sensed current of the first transistor (i.e., HS switch) via an adder circuit 318. The outputs of the plurality of EAs 316a-c are also coupled to a second terminal of the mode switch 310 at a shared common output node 320. The output of the PWM comparator 314 is coupled to a digital controller 322 where the digital controller 322 has a second input coupled to a reference clock. The digital controller 322 is configured to output drive control signals to the high-side driver amplifier 308 and low-side driver amplifier 324 based on the output of the PWM comparator 314 and the reference clock to control the first transistor 302 and the second transistor 304. The high-side driver amplifier 308 has a first voltage supply line coupled to a capacitor CBOOT (not shown) having a voltage of Vboot and a second voltage supply line coupled to receive a voltage from an output voltage node 326. As the voltage domain of the digital control signals (e.g., between 0-5V) is different from the voltage domain of the high-side driver amplifier 308 (e.g., between the voltage on the output voltage node 326 and Vboot), a level shifter 328 is coupled between the digital controller 322 and the input of the high-side driver amplifier 308 to level shift the voltage domain of the control signal from the digital controller 322 into the voltage domain range of the high-side driver amplifier 308. The low-side driver amplifier 324 has a first voltage supply line coupled to a supply voltage (VDD) and a second voltage supply line coupled to ground. As the voltage domain of the control signal from the digital controller 322 is configured to reside within the voltage domain of the low-side driver amplifier 324 (i.e., between 0-VDD), a level shifter is not needed, in this example, between the digital controller output and the input of the low-side driver amplifier 324.

In the example implementation as shown in FIG. 3, the first EA 316a is configured to output a difference between a reference value of a target battery voltage (vbat_ref) and a sensed voltage of the battery (vbat_fb). The second EA 316b is configured to output a difference between a reference input current value (iin_ref) and a sensed input current from VIN (iin_fb), where the input current values have been converted into corresponding voltage information. The third EA 316c is configured to output a difference between a reference charging current (ichg_ref) for the battery and a sensed charging current of the battery (ichg_fb), where the charging current values have been converted into corresponding voltage information. The EAs 316a-c may implement a compensation network (not shown) for stability of the corresponding control loop associated with EA (e.g., the control loop for the target battery voltage). In one implementation, one or more components of the compensation network may be adjustable to achieve control loop stability over various operating conditions. For example, adjustable capacitors and/or resistors may be implemented in the compensation network may be adjusted based on regulator mode of the multi-mode regulator. As another example, one or more components may be switched in or out, via switches, to select between different discrete component values (e.g., resistance and/or capacitance) to be used for the compensation network.

During operation of the multi-mode regulator, a selected one of the EAs 316a-c is active at a particular time to provide the corresponding difference value as an input to the PWM control logic 312. For example, the EAs 316a-c are implemented according to an open drain architecture where the EA can only pull down the amplifier output. In order to pull up the amplifier output, the EAs 316a-c share a common pull-up current source 330 coupled to the outputs of the EAs. By allowing the EAs to only pull down the amplifier outputs, the EAs 316a-c are able to share the shared common output node 320. Alternatively, the EAs 316a-c may be configured with the ability to pull up and pull down the output but where only the active EA is selectively coupled the shared common output node via switches coupled to the respectively outputs of the EAs 316a-c.

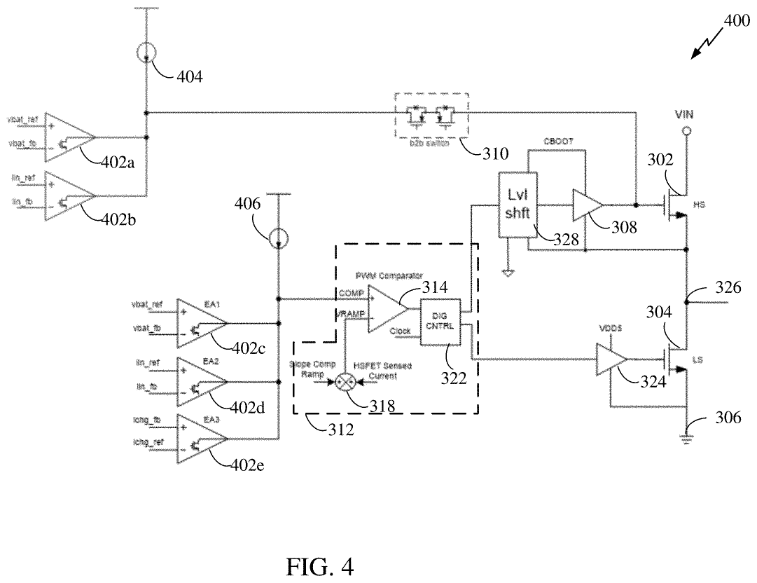

Referring now to FIG. 4, an example implementation of a multi-mode regulator 400 with separate mode feedback is illustrated, in accordance with various aspects of the present disclosure. The multi-mode regulator 400 is similar to the implementation of the multi-mode regulator 300, however the error amplifiers 402 are not shared between the regulation modes. Rather, EAs 402a-b are used for one or more linear regulation modes while EAs 404c-e are used for one or more switching regulation modes. In the example implementation of multi-mode regulator 400, EAs 402a-b share a common pull-up current source 404 and EAs 402c-e share a different common pull-up current source 406. However, in another implementation, the EAs 402a-402e may share a same common pull-up source which may be, for example, selectively coupled to the EAs associated to the implemented regulation mode.

An exemplary benefit of using different EAs between the regulation modes is that complexity of the EAs may be reduced as compared to if the EAs were shared between the linear and switching regulation modes. For example, the EAs may require different compensation networks (not shown) between the regulation modes. By using separate EAs between the regulation modes, a potential need to have a reconfigurable compensation network for the different regulation modes may be obviated.

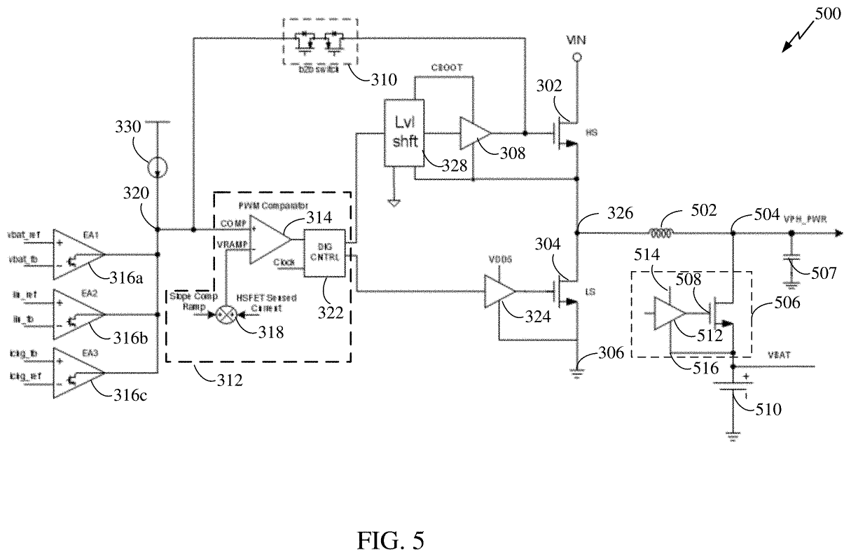

Referring now to FIG. 5, n example battery charging architecture 500 implementing the multi-mode regulator 300 of FIG. 3 configured in a switching regulation mode is illustrated, in accordance with various aspects of the present disclosure. In one implementation, the battery charging architecture 500 is implemented in a mobile device and is configured to charge a battery of the mobile device as well as provide power to the mobile device. The battery charging architecture 500 includes an output inductor 502 having a first terminal coupled to the output voltage node 326 of the multi-mode regulator 300. The second terminal of output inductor 502 is coupled to a charger output node 504 and a power supply line of a device (VPH_PWR) including a battery switch circuitry 506, which may further be coupled to an output capacitor 507. The battery switch circuitry 506 includes a battery switch 508 coupled between the charger output node 504 and a battery 510 (e.g., battery pack). The battery switch 508 is configured to selectively couple the battery 510 to the charger output node 504 via a voltage signal applied by an output of a battery switch driver amplifier 512 coupled to the gate terminal of the battery switch. For example, when the battery 510 reaches a maximum allowed battery voltage, the battery switch 508 can uncouple, via a bias applied to the gate terminal of the battery switch 508, the battery 510 from the charger output node 504 to prevent additional charging. The bias may be applied at the direction of a PMIC or other control logic. The battery switch driver amplifier 512 has a first voltage supply line 514 coupled to a first voltage source and a second voltage supply line 516 coupled to the output voltage (VBAT) of the battery 510. The output voltage VBAT (vbat_fb) is also coupled to the battery voltage feedback input of EA 316a. In one implementation, the first voltage source is based on VBAT and a voltage offset (e.g., 5V). By maintaining a voltage offset between the voltage (e.g., VBAT +5V) on the first voltage supply line 514 and the voltage (i.e., VBAT) on the second voltage supply line 516, the battery switch 508 may be driven at a particular voltage to maintain the on-resistance of the battery switch 508 to reduce power loss associated with the battery switch 508.

As the multi-mode regulator 300 is configured according to a switching regulation mode (e.g., as a buck converter), the mode switch 310 is configured to be turned off (i.e., opened) to uncouple the gate terminal of the first transistor 302 from the shared common output node 320 of the EAs 316a-c. The PWM control logic 312 controls the operation of the first transistor 302 (i.e., high-side switch) and the second transistor 304 (i.e., low-side switch) via control signals based on the output on the active EA and VRAMP.

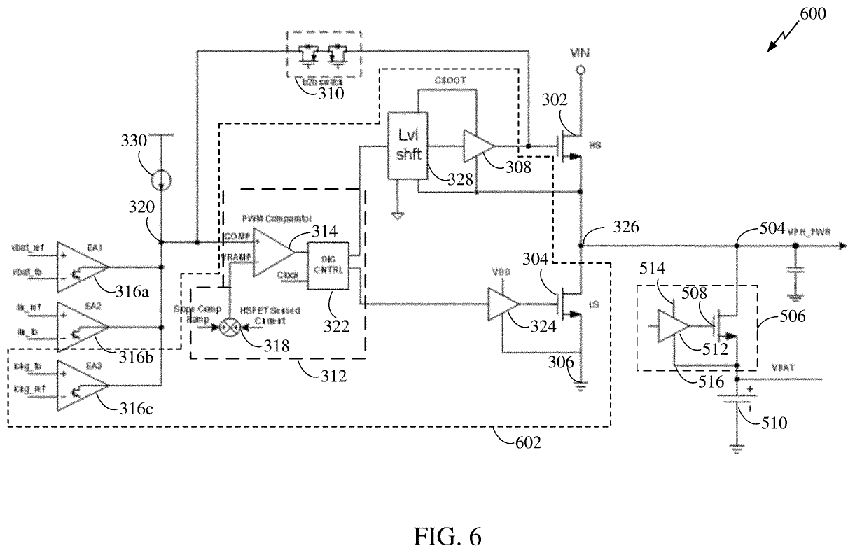

Referring now to FIG. 6, an example battery charging architecture of FIG. 5 configured in a linear regulation mode is illustrated, in accordance with various aspects of the present disclosure. The battery charging architecture 600 is similar to the battery charging architecture 500 of FIG. 5, however, no output inductor is coupled between the output voltage node 326 of the regulator and the charger output node 504 for the linear regulation mode.

As the multi-mode regulator is configured according to linear regulation mode (e.g., as an LDO), the mode switch 310 is configured to be turned on (i.e., closed) to couple the gate terminal of the first transistor 302 directly to the shared common output node 320 of the EAs 316a-c. The PWM control logic 312 is at least partially disabled, as the PWM control logic 312 is not responsible for driving at least the first transistor 302 during a linear regulation mode. In addition, the level shifter 328, high-side driver amplifier 308, the low-side driver amplifier 324, and the second transistor 304 are all disabled (i.e., turned off). Optionally, at least a portion of the PWM control logic 312, in addition to the second driver amplifier 324, may remain enabled to drive an output on the gate terminal of the second transistor 304 to turn off (i.e., open) the second transistor 304. Furthermore, as it is a characteristic for linear regulators to have an input current that matches the linear regulator's output current, the third EA 316c for the control loop of the charge current ichg (i.e., output current) may also be disabled to remove redundancy of control loops as the second EA 316b is a control loop for the input current iin. By disabling unused components (located within the exemplary dotted area 602) for the linear regulation mode, power may be saved as well as preventing unwanted interference between components of the linear and switching regulation modes. The enablement and disabled of these components may be based on control signals received an external processor or integrated circuit (IC), such as a PMIC, responsible for controlling the multi-mode regulator, and/or programming of configuration logic (not shown) of the multi-mode regulator.

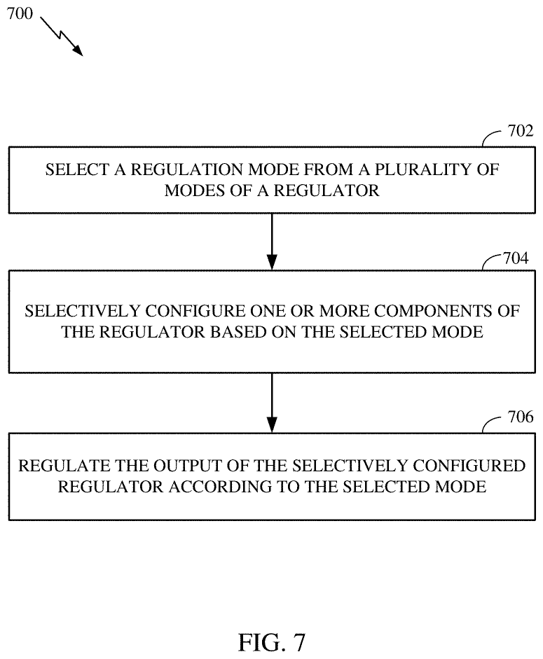

Referring now to FIG. 7, an example operation of a multi-mode regulation method 700 is illustrated.

At block 702, a regulation mode from a plurality of modes of a multi-mode regulator is selected. In one implementation, the regulation mode may be determined during the design of a device incorporating the multi-mode regulator. For example, a device manufacturer may choose to implement the multi-mode regulator according to a linear regulation mode in the device to avoid the necessity of incorporating an output inductor of the switching regulation mode, in an effort to reduce component costs and/or device area. The manufacturer of the device may further select to implement the multi-mode regulator to regulate an output voltage and/or an output current of the multi-mode regulator. To implement the selected mode, the manufacturer may program the multi-mode regulator to operate according to the selected more. In another implementation, the multi-mode regulator is configured receive a control signal from the device to operate according to the selected mode. In another implementation, the device may be designed to support both the linear and switching regulation modes of the multi-mode regulator. During run-time of the device, the multi-mode regulator may actively switch between the regulation modes based on one or more operational parameters of the device. For example, the output of the multi-mode regulator may provide an output voltage as a voltage supply to a plurality of different power amplifiers. For power amplifiers operating at a reduced power level compared to higher power amplifier, the linear regulation mode may be selected. For the higher power amplifiers, the multi-mode regulator, or other controlling logic, may select the switching regulation mode. Other examples of operational parameters include the difference between an input voltage of the multi-mode regulator versus the target output voltage of the multi-mode regulator and noise requirements for the output voltage of the regulator (e.g., ripple noise). An exemplary benefit of run-time switching between the regulation modes is that power efficiency may be improved and/or heat generation by the multi-mode regulator components may be reduced as compared to operating only in a single regulation mode.

At block 704, one or more components of the multi-mode regulator are configured based on the selected regulation mode. Configuration includes enabling and/or disabling the one or more components of the multi-mode regulator to achieve the selected regulation mode. For example, when a switching regulation mode is selected, the gate of the high-side switch is uncoupled from the outputs of one or more EAs, via a mode switch, so that the high-side switch is driven only via PWM control logic associated with the switching regulation mode. In one implementation, the regulation mode may further include whether to regulate the output of the regulator based on the output voltage, input current, and/or output current of the multi-mode regulator.

At block 706, the output of the selectively configured multi-mode regulator is regulated according to the selected mode. In one implementation, the multi-mode regulator is configured to regulate the output current (i.e., charge current) going into a battery until either sensing the battery has been charged to a maximum voltage or the input current is exceeding an input current maximum (e.g., from a load attack from the device which causes an increase current draw). In the instance of meeting the maximum battery voltage, the multi-mode regulator may switch to regulating the output based on the battery voltage. When the input current maximum is exceeded, the multi-mode regulator may regulate the output based on the input current so that the input current is below the maximum input current limit.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering. For example, means for selectively configuring one or more components may comprise the PMIC 124 of FIG. 1. Means for comparing a feedback value of the regulator against a reference value may comprise, for example, the EAs 208 of FIG. 2. Means for regulating the output of the multi-mode regulator may comprise, for example, the PWM control logic 312 and/or the EAs 316 of FIG. 3.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with discrete gate or transistor logic, discrete hardware components, or any combination thereof designed to perform the functions described herein.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A regulator supporting multiple modes, comprising:
a first transistor having a first terminal coupled to an input voltage and a second terminal coupled to an output of the regulator;
a second transistor having a first terminal coupled to the second terminal of the first transistor and a second terminal coupled to a reference potential;
pulse width modulation (PWM) control logic having a first output coupled to a gate of the first transistor and a second output coupled to a gate of the second transistor;
one or more error amplifiers configured to receive a reference value and a feedback value, at least one comparator of the one or more error amplifiers having an output coupled to an input of the PWM control logic; and
a switch with a first terminal coupled to the gate of the first transistor and a second terminal coupled to the output of one of the one or more error amplifiers.

2. The regulator of claim 1, wherein the regulator is configurable to operate in a selected mode, the selected mode, the selected mode being selected from among a linear regulation mode and a switching regulation mode.

3. The regulator of claim 2, wherein in the linear regulation mode:
the gate of the first transistor is configured to be driven by the output of the at least one comparator by a selective coupling via the switch;
the switch is configured to be in a closed state; and
the second transistor is configured to be in an open state.

4. The regulator of claim 3, wherein in the linear regulation mode:
at least a portion of the PWM control logic is configured to be disabled, the at least portion configured to selectively drive the gate of the first transistor.

5. The regulator of claim 2, wherein in the switching regulation mode:
the gates of the first transistor and second transistor are configured to be driven based on the first and second outputs of the PWM control logic; and
the switch is configured to be in an open state.

6. The regulator of claim 1, further comprising:
a first driver amplifier having an input coupled to the first output of the PWM control logic and an output coupled to the gate of the first transistor; and
a second driver amplifier having an input coupled to the second output of the PWM control logic and an output coupled to the gate of the second transistor.

7. The regulator of claim 6, further comprising a level shifter coupled between the first output of the PWM control logic and the input of the first driver amplifier.

8. The regulator of claim 1, further comprising a pull-up current source coupled to at least one output of the one or more error amplifiers.

9. A method of multi-mode regulation, comprising:
selecting a regulation mode from a plurality of modes of a regulator;
selectively configuring one or more components of the regulator based on the selected mode; and
regulating an output of the selectively configured regulator according to the selected mode.

10. The method of claim 9 wherein a first mode of the plurality of modes comprises a linear regulation mode and a second mode of the plurality of modes comprises a switching regulation mode.

11. The method of claim 10, wherein the selected mode comprises the first mode: and wherein selectively configuring comprises:
enabling a switch coupled between an output of at least one error amplifier and an input of a first transistor of the regulator; and
disabling at least a portion of a pulse width modulation (PWM) control logic having a first output coupled to the first transistor and a second output coupled to a second transistor of the regulator.

12. The method of claim 11, wherein the selective configuring further comprises disabling the low-side switch with an enabled portion of the PWM control logic.

13. The method of claim 10, wherein the selected mode comprises the second mode; and
wherein the selectively configuring comprises:
disabling a switch coupled between an output of at least one error amplifier and an input of a first transistor of the regulator; and
driving a gate of the first transistor switch based on a first output of a pulse width modulation (PWM) control logic; and
driving a gate of a second transistor of the regulator based on a second output of the PWM control logic.

14. The method of a claim 13, wherein the first and second outputs of the PWM control logic are based on the output of the at least one error amplifier.

15. The method of claim 13, wherein the first and second outputs of the PWM control logic are based on an output of a different error amplifier than the at least one error amplifier.

16. A multi-mode regulator, comprising:
means for selectively configuring one or more components of the regulator based on a selected regulation mode, the selected regulation mode being selected from among a linear mode and switching mode supported by the multi-mode regulator;
means for comparing a feedback value of the regulator against a reference value; and
means for regulating the output of the multi-mode regulator based on the selected mode and an output of the means for comparing.

17. The multi-mode regulator of claim 16, wherein the means for selectively configuring includes means for selectively coupling the means for comparing with a gate terminal of a high-side switch of the multi-mode regulator.

18. The multi-mode regulator of claim 16, wherein the means for selectively configuring includes means for selectively disabling at least a portion of the means for regulating.

19. A battery charging architecture, comprising:
a multi-mode regulator, comprising:
a first transistor having a first terminal coupled to an input voltage and a second terminal coupled to an output of the multi-mode regulator;
a second transistor having a first terminal coupled to the second terminal of the first transistor and a second terminal coupled to a reference potential;
pulse width modulation (PWM) control logic having a first output coupled to a gate of the first transistor and a second output coupled to a gate of the second transistor;
one or more error amplifiers configured to receive a reference value and a feedback value, at least one error amplifier of the one or more error amplifiers having an output coupled to an input of the PWM control logic; and
a switch with a first terminal coupled to the gate terminal of the first transistor and a second terminal coupled to the output of one of the one or more error amplifiers; and
a battery coupled to the output of the multi-mode regulator.

20. The battery charging architecture of claim 19, further comprising a battery switch coupled between an output of the battery charging architecture and a terminal of the battery.

21. The battery charging architecture of claim 20, further comprising an output inductor coupled between the output of the regulator and the output of the battery charging architecture.

22. The battery charging architecture of claim 21, wherein:
the multi-mode regulator is configured according to a switching regulation mode; and
the gate terminal of the first transistor is uncoupled from the output of the one or more error amplifiers via the switch.

23. The battery charging architecture of claim 19, further comprising a battery switch driver amplifier having an output coupled to a gate terminal of the battery switch.

24. The battery charging architecture of claim 20, wherein the battery switch driver amplifier further comprises:
a first supply line coupled to a first voltage supply; and
a second supply line coupled to the terminal of the battery.

25. The battery charging architecture of claim 20, wherein:
the multi-mode regulator is configured according to a linear regulation mode; and
the gate terminal of the first transistor is coupled to the output of the one or more error amplifiers via the switch.
